(19) United States
(12) Patent Application Publication
(10) Pub. No.: US 2005/0189476 A1
(43) Pub. Date: Sep. 1, 2005

(54) Photo cell and a gain control method thereof

(75) Inventors: Chang-Hyun Kim, Kyunggi-do (KR); Won-Tae Choi, Kyunggi-do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/813,930

(22) Filed: Mar. 31, 2004

(30) Foreign Application Priority Data
Feb. 26, 2004 (KR) 2004-13106

(51) Int. Cl. H01J 40/14

(52) U.S. Cl. 250/214 R

(57) ABSTRACT

A photocell used with an optical mouse, a CMOS sensor of a digital camera module, or a scanner includes a photo element in which a feedback circuit to maintain a base terminal voltage of the photo element constant, is not directly connected to a base terminal to control the voltage to directly maintain an emitter terminal voltage so that a stable bias voltage is generated compared to a conventional photo element. The photocell includes a stepping element to increase the voltage applied to the base terminal of the photocell, thereby improving sensitivity of the photocell and increasing effectiveness of light.

### CROSS-REFERENCE TO RELATED APPLICATIONS

This application claims the benefit of Korean Patent Application No. 2004-13106 filed with the Korea Industrial Property Office on Feb. 26, 2004, the disclosure of which is incorporated herein by reference.

### BACKGROUND OF THE INVENTION

1. Field of the Invention

The present invention relates to a photocell constituting a photocell array, and more particularly, to a photocell used with an optical mouse, a CMOS sensor of a digital camera module, or a scanner to maintain a uniform base terminal voltage of a phototransistor which is an amplifying element to form the photo element using a voltage stepping element and a voltage regulating loop circuit, to simultaneously generate a more stable bias voltage than a conventional circuit by increasing a base terminal voltage of the phototransistor, and to increase a light effectiveness by increasing a light sensitivity of the phototransistor.

2. Description of the Related Art

An IC is used with an optical mouse, a CMOS sensor of a digital camera module or a scanner to sense strength of light through a plurality of photocells to generate an image. In a case of the optical mouse, a movement direction of the optical mouse is transmitted to a PC according to the image sequentially caught in a time axis.

The photocell is generally constituted of a sub-PNP type (substrate PNP type) transistor made using a conventional CMOS manufacturing process different from the photodiode.

Since the conventional CMOS manufacturing process can be used to produce the sub-PNP type transistor, a cell library provided in a semiconductor manufacturing process can be used to secure a product reliability with a digital circuit, and a product developing period can be shortened according to a regulated flow of the manufacturing process to provide advantages in manufacturing the sub-PNP type transistor as the photocell.

A characteristic of the sub-PNP type transistor can deteriorate more than a general photodiode because the CMOS manufacturing process is not a specialized process of manufacturing the sub-PNP type transistor, and therefore, the sub-PNP type transistor needs an additional circuit to compensate for the deteriorating characteristic.

Since the additional circuit includes a plurality of arrays, the additional circuit should have a minimum size, and a design of the additional circuit should not be complicated. The sub-PNP type transistor should be satisfied with the above conditions, and the photocell is required to operate the sub-PNP type transistor at an optimized condition at the same time.

FIG. 1 is a view showing a structure of a sub-PNP type transistor 100 manufactured using a conventional CMOS process. Referring to FIG. 1, the sub-PNP type transistor 100 has a vertical structure. Since a substrate 106 of a p type base forms a collector, the collector is always connected to ground 104.

In a conventional CMOS manufacturing process, a PNP or NPN element cannot be used unless an additional layer is added. However, the sub-PNP type transistor 100 can be realized using an n-well 105 and the p-substrate (substrate having the p type base) 106. A SiO₂ layer 107 is formed (stacked) on the substrate 106.

As shown in FIG. 1, the p-substrate 106 of the sub-PNP type transistor 100 is always connected to the ground 104 to generate a reverse directional bias between a base terminal 101 and a collector terminal 103. A depletion region is formed due to the reverse directional bias.

In an area of the n-well 105, chargers formed by light may be recombined through a recombination process, but the chargers can be converted into a current in the depletion region. Accordingly, the light should arrive the depletion region in order fro the photocell to react the light. In order for the light to arrive the depletion region, the depletion region should be formed to be disposed adjacent to a surface of the photocell, and thus, sensitivity of the photocell can be improved as a reverse direction voltage between the base terminal 101 and the collector terminal 103 increases.

A CMOS (complementary MOSFET) has a structure having P- or N-doping formed on p-doped silicon, and a general CMOS is an NMOS or a PMOS. A conventional CMOS manufacturing process includes a method of doping the P or N doped on a base substrate. This conventional CMOS manufacturing process also includes a manufacturing method of forming a bipolar junction transistor (BJT) having a PNP bonding.

In contrast to the CMOS manufacturing process, the PNP or NPN bonding element is used to manufacture the BJT, and also a bi0CMOS manufacturing process can be used to use all of PNP, NPN, NMOS, and PMOS elements.

A photocell circuit includes a charging capacitor charging and discharging an electrical signal, and also includes a bias circuit or a stabilizing circuit to maintain a uniform base voltage of the phototransistor so as to stabilize an entire circuit by stabilizing an charging and discharging operation of the charging capacitor.

FIG. 2 is a view showing a photocell having a bias circuit to maintain a uniform voltage of a base terminal of a conventional photo sensor.

When a reset switch 207 is turned on, a charging capacitor 210 is charged to a predetermined voltage, for example 3.25V. A photodiode 203, a phototransistor 201, and a parasitic capacitor 202 form a photo element 204.

A current is generated when light is incident on the photodiode 203, which is a photoreceptor, and the phototransistor 201 is turned on according to the generated current so that the chargers of the charging capacitor 210 is transmitted to ground through the phototransistor 201. Accordingly, the charging capacitor 210 is discharged to a predetermined voltage.

As shown in FIG. 2. a base node (terminal) of the phototransistor 201 is connected to a gate terminal of a first transistor 205, and a drain terminal of the first transistor 205 is connected to a constant current source and a gate terminal of a second transistor 208.

A source terminal of the second transistor 208 is connected to an emitter terminal of the phototransistor 201. The second transistor 208 is operated as a source follower to transmit a drain voltage of the first transistor 205 to the emitter terminal of the phototransistor 201. The source follower is a circuit to transmit an input AC signal as an output AC signal. That is, although a DC bias is changed, an amplitude of an input signal has the same as an output signal in a circuit of the source follower. The AC signal inputted to the collector terminal of the second transistor 208 is transmitted to the collector terminal of the phototransistor 201 while maintaining the amplitude.

A negative feedback loop having MOS transistors 205 and 208 is formed between the base terminal and the emitter terminal of the phototransistor 201. With this native feedback loop, the bias voltage of the base terminal of the phototransistor 201 is maintained constant.

That is, a voltage of the base terminal of the phototransistor 201 increases, a resistance of the first transistor 205 is decreased, and a voltage of the gate terminal of the second transistor 208 is decreased. According to a source follower operation of the second transistor 208, a voltage of the emitter terminal of the first transistor 201 is decreased, and the voltage of the base terminal of the phototransistor 201 is decreased.

The voltage of the base terminal of the phototransistor 201 decreases, the resistance of the first transistor 205 is increased, and the voltage of the gate terminal of the second transistor 208 is increased. According to the source follower operation of the second transistor 208, the voltage of the emitter terminal of the first transistor 201 is increased, and the voltage of the base terminal of the phototransistor 201 is increased.

After the charging capacitor 210 is discharged, the chargers charged in the charging capacitor 210 is transmitted to a transfer capacitor 211 when a read switch is turned on, and the transmitted chargers is amplified to be transmitted to an external circuit which reads the chargers (current).

U.S. Pat. No. 5,769,384 discloses a photocell having a bias circuit to maintain a bias voltage constant to supply a base terminal of a phototransistor.

However, since a voltage of the base terminal of the phototransistor shown in U.S. Pat. No. 5,769,384 is low, the sensitivity of the phototransistor is decreased, and light effectiveness of the phototransistor deteriorates.

As described above, the bias voltage supplied to the base terminal of the phototransistor is required to be increased in order to solve problems occurring in a conventional circuit, and a photocell IC circuit is required to provide a simply and easily designed and manufactured structure while the light sensitivity of the photocell circuit is improved.

### SUMMARY OF THE INVENTION

In order to solve the above and/or other problems, it is an aspect of the present invention to provide a photocell forming a photocell array, the photocell being simple in designing and being able to operate a sub-PNP type transistor at an optimized state.

It is another aspect of the present invention to provide a photocell generating a more stable phototransistor bias voltage by increasing a voltage of a base terminal of the phototransistor, which is an amplifying element of a photo element, to improve light effectiveness and sensitivity of the phototransistor.

Additional aspects and advantages of the invention will be set forth in part in the description which follows and, in part, will be obvious from the description, or may be learned by practice of the invention.

The above and/or other aspects of the present invention can be achieved by providing a photocell including: a photo element having an emitter terminal and a base terminal to generate a current according to an incident light signal; a charging capacitor to discharge current charged therein when the light signal is inputted to the photo element; a voltage control circuit connected to the emitter terminal of the photo element to maintain a voltage of the emitter terminal of the photo element constant; and at least one voltage stepping element connected to the voltage control circuit to step the voltage of the emitter of the photo element by a predetermined segment.

According to another aspect of the present invention, the photo element comprises a photo receptor to receive the light signal, and a current amplifier, and the photo receptor is connected to the base terminal of the current amplifier.

According to yet another aspect of the present invention, the voltage of the base terminal of the photo element linearly varies according to a variation of a voltage of the emitter terminal of the photo element.

According to still another aspect of the present invention, the photo element further includes a reset unit to reset the charging capacitor to charge the charging capacitor.

According to still yet another aspect of the present invention, the photo element further includes a constant current source connected to the voltage control circuit to supply a constant current to the photo element.

According to also an aspect of the present invention, the voltage stepping element comprises a MOS transistor having a drain terminal and a gate terminal connected to each other.

According to another aspect of the present invention, the voltage stepping element comprises a diode.

According to another aspect of the present invention, the voltage stepping element comprises a plurality of sub-voltage stepping elements connected in series.

According to another aspect of the present invention, the voltage control circuit comprises a first MOS transistor and a second MOS transistor, a drain terminal of the first MOS transistor is connected to a gate terminal of the second MOS transistor, and a gate terminal of the first MOS transistor is connected to a source terminal of the second MOS transistor and an emitter terminal of the photo element.

The above and/or other aspects of the present invention can also be achieved by providing a photocell including: a photo element having an emitter terminal and a base terminal to generate a current according to an incident light signal; a charging capacitor to discharge current charged therein when the light signal is inputted to the photo element; a voltage control circuit connected to the emitter terminal of the photo element to maintain a voltage of the emitter terminal of the photo element constant; at least one voltage stepping element connected to the voltage control circuit to step the voltage of the emitter of the photo element by a predetermined segment; and a shutter to control a discharging characteristic of the charging capacitor according to strength of light incident on the photo element.

According to another aspect of the present invention, the photo element comprises a photo receptor to receive the light signal, and a current amplifier, and the photo receptor is connected to the base terminal of the current amplifier.

According to yet another aspect of the present invention, the voltage of the base terminal of the photo element linearly varies according to a variation of a voltage of the emitter terminal of the photo element.

According to still another aspect of the present invention, the photocell further includes a reset unit to reset the charging capacitor to charge the charging capacitor.

According to still yet another aspect of the present invention, the photocell further includes a constant current source connected to the voltage control circuit to supply a constant current to the photo element.

According to another aspect of the present invention, the voltage stepping element comprises a MOS transistor having a drain terminal and a gate terminal connected to each other.

According to another aspect of the present invention, the voltage stepping element comprises a diode.

According to another aspect of the present invention, the voltage stepping element comprises a plurality of sub-voltage stepping elements connected in series.

According to another aspect of the present invention, the voltage control circuit includes a first MOS transistor and a second MOS transistor, a drain terminal of the first MOS transistor is connected to a gate terminal of the second MOS transistor, and a gate terminal of the first MOS transistor is connected to a source terminal of the second MOS transistor and an emitter terminal of the photo element.

According to another aspect of the present invention, the discharging characteristic of the charging capacitor is a first speed when the strength of the light incident on the photo element is in a first state, and the discharging characteristic of the charging capacitor is a second speed slower than the first speed when the strength of the light incident on the photo element is in a second state weaker than the first state.

The above and/or other aspects of the present invention can be also achieved by providing an automatic gain control method of a photocell, the method including: generating a current according to an incident light signal in a photo element having an emitter terminal and a base terminal; discharging current charged in a charging capacitor when the light signal is inputted to the photo element; maintaining a voltage of the emitter terminal of the photo element constant in a voltage control circuit connected to the emitter terminal of the photo element; and controlling the voltage of the emitter of the photo element to be constant in at least one voltage stepping element connected to the voltage control circuit.

According to another aspect of the present invention, the maintaining of the voltage comprises maintaining a voltage of the base terminal of the photo element constant, and the voltage of the base terminal of the photo element linearly varies according to a variation of the voltage of the base terminal of the photo element.

According to yet another aspect of the present invention, the automatic gain control method further includes charging the charging capacitor according to a reset signal.

According to still another aspect of the present invention, the automatic gain control method further includes reading a voltage generated from the charging capacitor after the discharging of the charging capacitor is completed.

The above and/or other aspects of the present invention can be also achieved by providing an automatic gain control method of a photocell, the method including: generating a current according to an incident light signal in a photo element having an emitter terminal and a base terminal; discharging current charged in a charging capacitor when the light signal is inputted to the photo element; controlling a discharging time of the charging capacitor according to the light signal in a shutter; maintaining a voltage of the emitter terminal of the photo element constant in a voltage control circuit connected to the emitter terminal of the photo element; and controlling the voltage of the emitter of the photo element to be constant in at least one voltage stepping element connected to the voltage control circuit.

According to another aspect of the present invention, the maintaining of the voltage comprises maintaining a voltage of the base terminal of the photo element constant.

According to yet another aspect of the present invention, the voltage of the base terminal of the photo element linearly varies according to a variation of the voltage of the base terminal of the photo element.

According to still another aspect of the present invention, the automatic gain control method further includes charging the charging capacitor according to a reset signal.

According to still yet another aspect of the present invention, the charging capacitor is discharged when a shutter signal is a first state in the shutter, and the discharging of the charging capacitor is stopped when the shutter signal is a second state in the shutter.

According to yet another aspect of the present invention, the automatic gain control method further includes reading a voltage generated from the charging capacitor after the discharging of the charging capacitor is completed.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a view showing a structure of a sub-PNP type transistor manufactured using a conventional CMOS process;

FIG. 2 is a view showing a photocell having a bias circuit to maintain a uniform voltage of a base terminal of a conventional photo sensor;

FIG. 3 is a view showing a photocell according to an embodiment of the present invention;

FIG. 4 is a view showing an MOSFET used with the photocell shown in FIG. 3;

FIG. 5 is a view showing a photocell according to another embodiment of the present invention; and

FIG. 6 is a graph showing outputs of the photocell of FIGS. 3 and 5 and a conventional photocell when light is incident on the photocell of FIGS. 3 and 5 and the conventional photocell, respectively.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

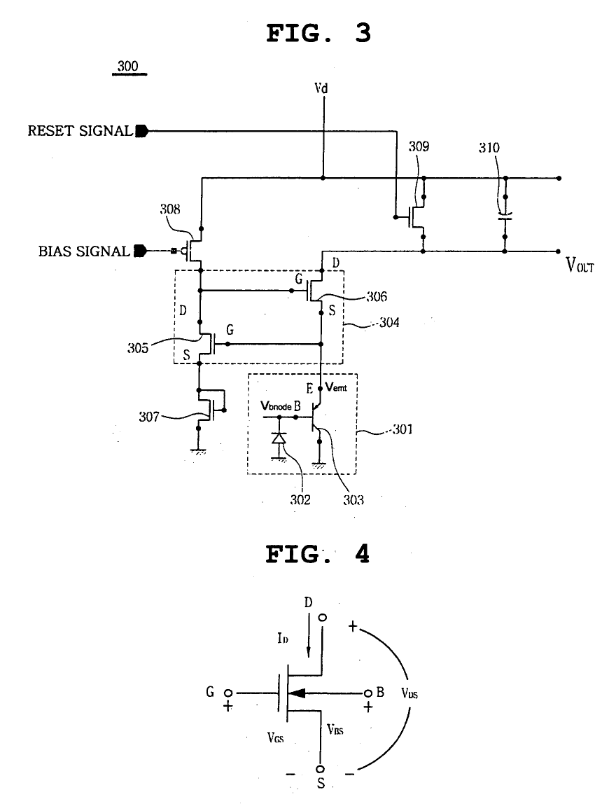

FIG. 3 is a view showing a photocell 300 according to an embodiment of the present invention.

A photocell element 301 may include a photodiode 302 to receive a light signal, generate a current in response to the received light signal, and amplify the generated current, and a phototransistor 303 to amplify the current generated from photodiode 302 as an amplifying element.

A voltage control circuit 304 may include a first MOS transistor 305 and a second MOS transistor 306 to maintain a base terminal voltage V_{bnode} constant according to this embodiment.

As shown in FIG. 3, the voltage control circuit 304 may include the first MOS transistor 305 and the second MOS transistor 306, a drain terminal of the first MOS transistor 305 is connected to a gate terminal of the second MOS transistor 306, and a gate terminal of the first MOS transistor 305 can be connected to a source terminal of the second MOS transistor 306 and an emitter terminal of the phototransistor 303.

When a voltage Vₑₘₜ of the emitter terminal of the phototransistor 303 is increased, a resistance of the first MOS transistor 305 is decreased, a voltage of the gate terminal of the second MOS transistor 306 is decreased, a voltage of a source terminal of the second MOS transistor 306 is decreased, and accordingly the voltage Vₑₘₜ of the emitter terminal of the phototransistor 303 is increased. When the voltage Vₑₘₜ of the emitter terminal of the phototransistor 303 is decreased, the resistance of the first MOS transistor 305 is increased, a voltage of a drain terminal of the first MOS transistor, that is, the voltage of the gate terminal of the second MOS transistor 306, is increased, and accordingly the voltage Vₑₘₜ of the emitter terminal of the phototransistor 303 is increased
According to the above-described mechanism of the photocell 300, the voltage Vₑₘₜ of the emitter terminal of the phototransistor 303 can be maintained a constant voltage, and also the voltage V_{bnode} of the base terminal of the phototransistor 303 can be maintained constant.

In the photocell 300 according to this embodiment, one or more voltage stepping elements 307 can be connected to the first MOS transistor 305 to increase the voltage V_{bnode} of the emitter terminal maintained by the above-described mechanism. In this embodiment as shown in FIG. 3, an MOS transistor having a drain terminal and a gate terminal, which are connected to each other, is used as the one or more voltage stepping elements 307. When a number of MOS transistors are connected, the voltage V_{bnode} can be increased according to a total voltage proportional to a multiplication of a threshold voltage and the number of the voltage stepping elements 307, thereby increasing a reverse directional bias voltage applied to the base terminal of the phototransistor 303.

According to another aspect of the present invention, a diode or a resistance element having a predetermined threshold voltage can be used as the voltage stepping element 307.

A base terminal of the phototransistor 303 is an input terminal to receive an optical signal and is in an open state.

The constant current source 308 is a portion of a mirror circuit to supply a current to operate the photocell 300.

An operation of the photocell will be described hereinafter.

A bias voltage can be inputted from the constant current source 308 as a bias signal, such as less than ten nA. When a reset signal is inputted, a reset unit 309 is turned on, the charging capacitor 310 is charged to a predetermined voltage. When the light signal is inputted to the photodiode 302, a current is generated to discharge a charged current from the charging capacitor 310 through the phototransistor 303.

Here, the voltage control circuit 304 maintains the voltage V_{bnode} of the emitter terminal of the phototransistor 303 constant using the above-described mechanism.

During discharging the charging capacitor 310, a remaining charge remaining on the charging capacitor 310 is outputted to an external circuit to be read as an output.

In the photocell 300 according to this embodiment of the present invention, the bias voltage applied to the base terminal of the phototransistor 303 is explained hereinafter.

FIG. 4 is a view showing an n-channel MOSFET used with the photocell shown in FIG. 3. Referring to FIG. 4, when a transistor is saturated, a drain current i_{D} is as follows.

$${i}_{D} = \frac{W {μ}_{0} {C}_{ox}}{L} [ ( {v}_{GS} - {V}_{T} ) {v}_{DS} - \frac{{v}_{DS}^{2}}{2} ] ( 1 + λ {v}_{DS} ) \qquad ( 1 )$$

When the transistor is not saturated, the drain current i_{D} is as follows.

$$\begin{matrix}{i}_{D} = \frac{W {μ}_{0} {C}_{ox}}{L} [ ( {v}_{GS} - {V}_{T} ) {v}_{DS ( sat ) -} \frac{{v}_{DS ( sat )}^{2}}{2} ] ( 1 + λ {v}_{DS} ) & ( 2 ) \\ = \frac{W {μ}_{0} {C}_{ox}}{2 L} {( {v}_{GS} - {V}_{T} )}^{2} ( 1 + λ {v}_{DS} ) & \end{matrix}$$

Here, μₒ(cm^{2/volt·sec}) is a movement when an electrical field is zero, Cₒₓ(F/cm²) iₛ a unit of gate oxide capacitance per area, λ(volts⁻¹) is a channel modulation parameter, V_{T}=V_{TO}+γ(\sqrt{2|ψ_{f}|+|v_{BS}|}−\sqrt{2|ψ_{f}|}), V_{TO} is a critical voltage when a bias is zero, γ(volts^{-0.5)} is a bulk critical parameter, and 2|ψ_{f}|(volts) is a strong reverse surface potential.

With respect to a p-channel MOSFET, the same formula as the above formula is used except a reverse direction of the current.

According to the above formula (2), when the n channel MOS is saturated, λ<<1.

$$\begin{matrix}{i}_{D} = \frac{W}{2 L} {μ}_{0} {{C}_{ox} ( {v}_{GS} - {V}_{T} )}^{2} & ( 3 ) \\ {v}_{GS} = \sqrt{\frac{2 {i}_{D}}{\frac{W}{L} {μ}_{0} {C}_{ox}}} + {V}_{T} & ( 4 )\end{matrix}$$

Referring to FIG. 3, when a voltage between the gate and the source of the voltage stepping element 307 is V_{GS1}, and a voltage between the gate and the source of the first MOS transistor 305 is V_{GS2}, Vₑₘₜ is as follows.
Vₑₘₜ=V_{GS1}+V_{GS2} (5)

When the drain voltage of the voltage stepping element 307 and the first MOS transistor 305 is I, Vₑₘₜ is as follows.

$$Vemt = \sqrt{\frac{2 I}{{μ}_{0} {C}_{ox} \frac{{W}_{1}}{{L}_{1}}}} + \sqrt{\frac{2 I}{{μ}_{0} {C}_{ox} \frac{{W}_{2}}{{L}_{2}}}} + {V}_{T1} + {V}_{T2} \qquad ( 6 )$$

In the above formula, a subscript 1 indicates the voltage stepping element 307, and a subscript 2 indicates the first MOS transistor 305.

In FIG. 3, when V_{bnode}=Vₑₘₜ−V_{be}(7), a voltage of the base terminal of the phototransistor 303 is as follows.

$$\begin{matrix}A & ( 8 ) \\ Vbnode = \sqrt{\frac{2 I}{{μ}_{0} {C}_{ox} \frac{{W}_{1}}{{L}_{1}}}} + \sqrt{\frac{2 I}{{μ}_{0} {C}_{ox} \frac{{W}_{2}}{{L}_{2}}}} + {V}_{T1} + {V}_{T2} - {V}_{be} & \end{matrix}$$

In a conventional circuit, the voltage V_{bnode} of the base terminal is as follows.

$$Vbnode = \sqrt{\frac{2 I}{{μ}_{0} {C}_{ox} \frac{W}{L}}} + {V}_{T} - {V}_{b e}$$

According to the formulas (8) and (9), the voltage V_{bnode} can be increased higher than a conventional circuit using a W/L ratio of the voltage stepping element.

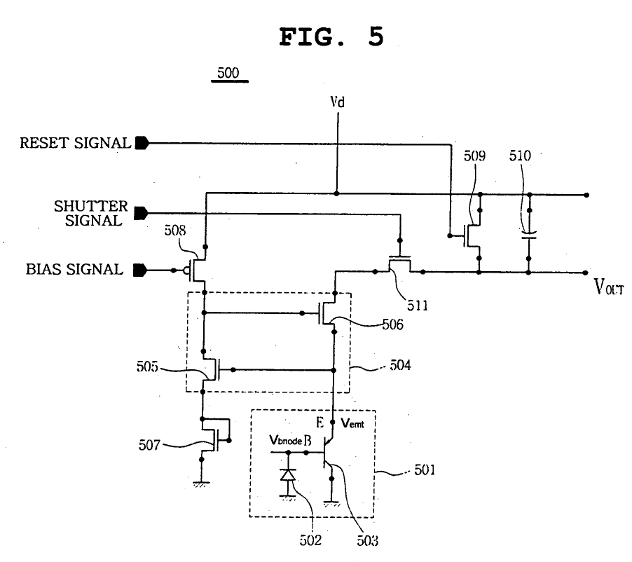

FIG. 5 is a view showing a photocell 500 according to another embodiment of the present invention.

A photocell element 301 may include a photodiode 502 to receive a light signal, generate a current in response to the received light signal, and amplify the generated current, and a phototransistor 503 to amplify the current generated from photodiode 502 as an amplifying element.

The phototransistor 503 is a sub-PNP type transistor.

A voltage control circuit 504 may include a first MOS transistor 505 and a second MOS transistor 506 to maintain a base terminal voltage V_{bnode} constant according to this embodiment.

As shown in FIG. 5, the voltage control circuit 504 may include the first MOS transistor 505 and the second MOS transistor 506, a drain terminal of the first MOS transistor 505 is connected to a gate terminal of the second MOS transistor 506, and a gate terminal of the first MOS transistor 505 can be connected to both a source terminal of the second MOS transistor 506 and an emitter terminal of the phototransistor 503.

When a voltage Vₑₘₜ of the emitter terminal of the phototransistor 503 is increased, a resistance of the first MOS transistor 505 is decreased, a voltage of the gate terminal of the second MOS transistor 506 is decreased, a voltage of a source terminal of the second MOS transistor 356 is decreased, and accordingly the voltage Vₑₘₜ of the emitter terminal of the phototransistor 503 is increased. When the voltage Vₑₘₜ of the emitter terminal of the phototransistor 503 is decreased, the resistance of the first MOS transistor 505 is increased, a voltage of a drain terminal of the first MOS transistor 505, that is, the voltage of the gate terminal of the second MOS transistor 506, is increased, and accordingly the voltage Vₑₘₜ of the emitter terminal of the phototransistor 503 is increased

According to the above-described mechanism of the photocell 500, the voltage Vₑₘₜ of the emitter terminal of the phototransistor 503 can be maintained a constant voltage, and also the voltage V_{bnode} of the base terminal of the phototransistor 503 can be maintained constant.

In the photocell 500 according to this embodiment, one or more voltage stepping elements 507 can be connected to the first MOS transistor 505 to increase the voltage V_{bnode} of the emitter terminal maintained by the above-described mechanism. In this embodiment as shown in FIG. 5, an MOS transistor having a drain terminal and a gate terminal, which are connected to each other, is used as the one or more voltage stepping elements 507. When a number of MOS transistors are connected, the voltage V_{bnode} can be increased according to a total voltage proportional to a multiplication of a threshold voltage and the number of the voltage stepping elements 507, thereby increasing a reverse directional bias voltage applied to the base terminal of the phototransistor 503.

According to another aspect of the present invention, a diode or a resistance element having a predetermined threshold voltage can be used as the voltage stepping element 507.

A base terminal of the phototransistor 503 is an input terminal to receive an optical signal and is in an open state.

A constant current source 508 is a portion of a mirror circuit to supply a current to operate the photocell 500.

An operation of the photocell 500 will be described hereinafter.

A bias voltage can be inputted from the constant current source 308 as a bias signal, such as less than ten nA. When a reset signal is inputted, a reset unit 509 is turned on, the charging capacitor 510 is charged to a predetermined voltage. When the light signal is inputted to the photodiode 502, a current is generated to discharge a charged current from the charging capacitor 510 through the phototransistor 503.

Here, the voltage control circuit 504 maintains the voltage V_{bnode} of the emitter terminal of the phototransistor 503 constant using the above-described mechanism.

During discharging the charging capacitor 510, a remaining charge remaining on the charging capacitor 510 is outputted to an external circuit to be read as an output.

A shutter 511 controls a discharging time of the charges charged in the charging capacitor 510 according to a strength of light incident on the photo element 501. That is, the discharging time of the charging capacitor 510 is determined from a time when the reset signal is changed to a low signal, to a time when an input of the shutter 511 is changed to a low signal. When the light strength is strong, the shutter 511 is turned on during a shortened period of time so that the discharging time of the charging capacitor 510 is shortened. However, the light strength is weak, the shutter 511 is turned on during an extended period of time so that the discharging time of the charging capacitor 510 is extended (lengthened).

When the shutter 511 is shut (turned off), that is, the discharging of the charging capacitor 510 is finished (stopped), the voltage value due to the charges remaining on the charging capacitor 510 is outputted to an external circuit as an output signal V_{OUT}.

In the photocell 500 according to this embodiment of the present invention, the voltage V_{bnode} of the base terminal of the phototransistor 503 is higher than the voltage shown in Formula (10) and supplies the higher reverse directional bias voltage to the base terminal of the phototransistor 503 than a conventional circuit.

Since the voltage of the base terminal of the photocell 500 is increased, the sensitivity of the photocell is improved.

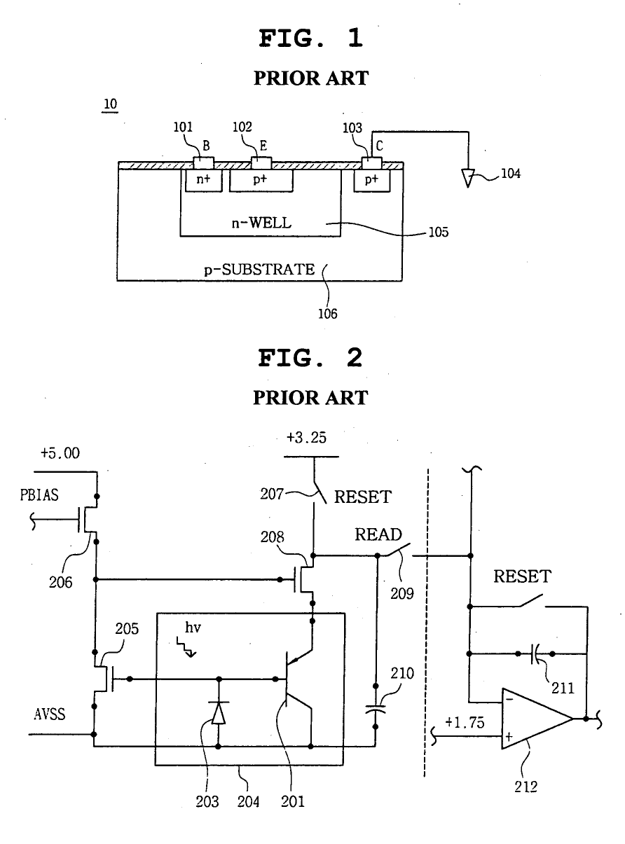

That is, referring to FIG. 1, a depletion region should be disposed adjacent to a surface of a photocell so that light reaches the depletion region of the sub-PNP type transistor, and the reverse directional voltage should be increased to dispose the depletion region adjacent to the surface. According to the embodiments of the present invention, the reverse directional voltage between the baser terminal and the emitter terminal is higher than a conventional circuit, thereby improving the sensitivity of the photocell.

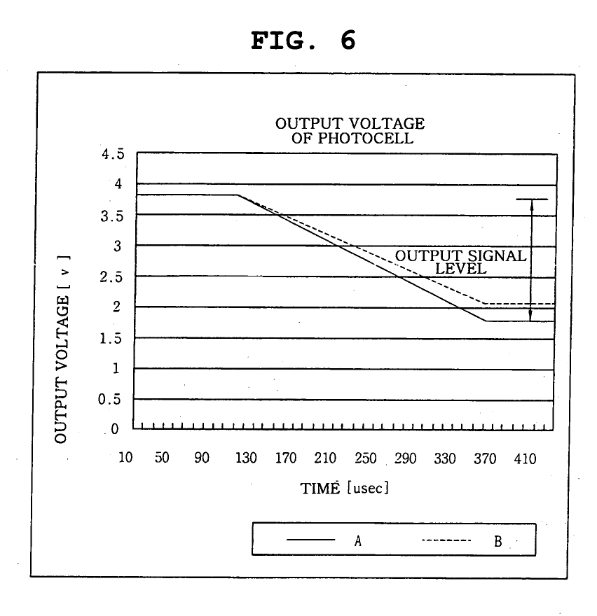

FIG. 6 is a graph showing outputs of the photocell shown in FIGS. 3 and 5 and a conventional photocell when light is incident on the photocell of the present invention and the conventional photocell, respectively. When the light having the same strength is incident on the photocell, the read output voltage signals are shown in a solid line and a broken line.

As shown in FIG. 6, when the light having the same strength is incident on the phototransistor, the output signal level of a conventional circuit B is about 1.79V according to a current generated from the incident light. However, the output signal level of the present embodiment circuit A is about 2.1V. The photocell of the present embodiment circuit A is improved by about 17% with respect to the same light having the same strength compared to the conventional circuit A.

According to an aspect of the present invention, although the photocell has a minimum circuit size, the design of the photocell does not become complicated, and a plurality of photocells can be arranged using an additional circuit. In addition, the photocell can operate the sub-PNP type transistor at the optimized state.

According to another aspect of the present invention, in the photocell circuit, the sensitivity of the phototransistor can be improved when the voltage of the base terminal of the phototransistor is increased.

According to another aspect of the present invention, the voltage of the base terminal of the phototransistor can be higher than a conventional photocell circuit, thereby improving the light effectiveness of the phototransistor.

The photocell described above is an example according to the embodiments of the present invention. However, the present invention is not limited thereto.

Although a few embodiments of the present invention have been shown and described, it will be appreciated by those skilled in the art that changes may be made in these embodiments without departing from the principles and spirit of the invention, the scope of which is defined in the appended claims and equivalents thereof.

1. A photocell comprising:
a photo element having an emitter terminal and a base terminal to generate a current according to an incident light signal;
a charging capacitor to discharge current charged therein when the light signal is inputted to the photo element;
a voltage control circuit connected to the emitter terminal of the photo element to maintain a voltage of the emitter terminal of the photo element constant; and
at least one voltage stepping element connected to the voltage control circuit to step the voltage of the emitter of the photo element by a predetermined segment.

2. The photocell of claim 1, wherein the photo element comprises a photo receptor to receive the light signal, and a current amplifier, and the photo receptor is connected to the base terminal of the current amplifier.

3. The photocell of claim 1, wherein the voltage of the base terminal of the photo element linearly varies according to a variation of a voltage of the emitter terminal of the photo element.

4. The photocell of claim 1, further comprising:
a reset unit to reset the charging capacitor to charge the charging capacitor.

5. The photocell of claim 1, further comprising:
a constant current source connected to the voltage control circuit to supply a constant current to the photo element.

6. The photocell of claim 1, wherein the voltage stepping element comprises a MOS transistor having a drain terminal and a gate terminal connected to each other.

7. The photocell of claim 1, wherein the voltage stepping element comprises a diode.

8. The photocell of claim 1, wherein the voltage stepping element comprises a plurality of sub-voltage stepping elements connected in series.

9. The photocell of claim 1, wherein the voltage control circuit comprises a first MOS transistor and a second MOS transistor, a drain terminal of the first MOS transistor is connected to a gate terminal of the second MOS transistor, and a gate terminal of the first MOS transistor is connected to a source terminal of the second MOS transistor and an emitter terminal of the photo element.

10. A photocell comprising:
a photo element having an emitter terminal and a base terminal to generate a current according to an incident light signal;
a charging capacitor to discharge current charged therein when the light signal is inputted to the photo element;
a voltage control circuit connected to the emitter terminal of the photo element to maintain a voltage of the emitter terminal of the photo element constant;
at least one voltage stepping element connected to the voltage control circuit to step the voltage of the emitter of the photo element by a predetermined segment; and
a shutter to control a discharging characteristic of the charging capacitor according to strength of light incident on the photo element.

11. The photocell of claim 10, wherein the photo element comprises a photo receptor to receive the light signal, and a current amplifier, and the photo receptor is connected to the base terminal of the current amplifier.

12. The photocell of claim 10, wherein the voltage of the base terminal of the photo element linearly varies according to a variation of a voltage of the emitter terminal of the photo element.

13. The photocell of claim 10, further comprising:
a reset unit to reset the charging capacitor to charge the charging capacitor.

14. The photocell of claim 10, further comprising:
a constant current source connected to the voltage control circuit to supply a constant current to the photo element.

15. The photocell of claim 10, wherein the voltage stepping element comprises a MOS transistor having a drain terminal and a gate terminal connected to each other.

16. The photocell of claim 10, wherein the voltage stepping element comprises a diode.

17. The photocell of claim 10, wherein the voltage stepping element comprises a plurality of sub-voltage stepping elements connected in series.

18. The photocell of claim 10, wherein the voltage control circuit comprises a first MOS transistor and a second MOS transistor, a drain terminal of the first MOS transistor is connected to a gate terminal of the second MOS transistor, and a gate terminal of the first MOS transistor is connected to a source terminal of the second MOS transistor and an emitter terminal of the photo element.

19. The photocell of claim 10, wherein the discharging characteristic of the charging capacitor is a first speed when the strength of the light incident on the photo element is in a first state, and the discharging characteristic of the charging capacitor is a second speed slower than the first speed when the strength of the light incident on the photo element is in a second state weaker than the first state.

20. An automatic gain control method of a photocell, the method comprising:
generating a current according to an incident light signal in a photo element having an emitter terminal and a base terminal;
discharging current charged in a charging capacitor when the light signal is inputted to the photo element;
maintaining a voltage of the emitter terminal of the photo element constant in a voltage control circuit connected to the emitter terminal of the photo element; and
controlling the voltage of the emitter of the photo element to be constant in at least one voltage stepping element connected to the voltage control circuit.

21. The automatic gain control method of claim 20, wherein the maintaining of the voltage comprises maintaining a voltage of the base terminal of the photo element constant.

22. The automatic gain control method of claim 20, wherein the voltage of the base terminal of the photo element linearly varies according to a variation of the voltage of the base terminal of the photo element.

23. The automatic gain control method of claim 20, further comprising:
charging the charging capacitor according to a reset signal.

24. The automatic gain control method of claim 20, further comprising:
reading a voltage generated from the charging capacitor after the discharging of the charging capacitor is completed.

25. An automatic gain control method of a photocell, the method comprising:
generating a current according to an incident light signal in a photo element having an emitter terminal and a base terminal;
discharging current charged in a charging capacitor when the light signal is inputted to the photo element;
controlling a discharging time of the charging capacitor according to the light signal in a shutter;
maintaining a voltage of the emitter terminal of the photo element constant in a voltage control circuit connected to the emitter terminal of the photo element; and
controlling the voltage of the emitter of the photo element to be constant in at least one voltage stepping element connected to the voltage control circuit

26. The automatic gain control method of claim 25, wherein the maintaining of the voltage comprises maintaining a voltage of the base terminal of the photo element constant.

27. The automatic gain control method of claim 25, wherein the voltage of the base terminal of the photo element linearly varies according to a variation of the voltage of the base terminal of the photo element.

28. The automatic gain control method of claim 25, further comprising:
charging the charging capacitor according to a reset signal.

29. The automatic gain control method of claim 25, wherein the charging capacitor is discharged when a shutter signal is a first state in the shutter, and the discharging of the charging capacitor is stopped when the shutter signal is a second state in the shutter.

30. The automatic gain control method of claim 25, further comprising:
reading a voltage generated from the charging capacitor after the discharging of the charging capacitor is completed.
